(19) United States
(12) Patent Application Publication
(10) Pub. No.: US 2014/0077991 A1
(43) Pub. Date: Mar. 20, 2014

(54) ENHANCED BROADCAST EPHEMERIS FOR HIGH ACCURACY ASSISTED GPS POSITIONING

(71) Applicant: CALIFORNIA INSTITUTE OF TECHNOLOGY, Pasadena, CA (US)

(72) Inventors: Yoaz E. BAR-SEVER, ALTADENA, CA (US); Byron A. IIJIMA, GRANADA HILLS, CA (US)

(73) Assignee: CALIFORNIA INSTITUTE OF TECHNOLOGY, Pasadena, CA (US)

(21) Appl. No.: 14/023,186

(22) Filed: Sep. 10, 2013

Related U.S. Application Data
(60) Provisional application No. 61/703,737, filed on Sep. 20, 2012.

(51) Int. Cl. G01S 19/27

(52) U.S. Cl. CPC G01S 19/27
USPC 342/357.66

(57) ABSTRACT

Systems and methods for enhanced broadcast ephemeris are described. These systems and methods include the calculation and transmission of globally and locally optimized parameters of the broadcast ephemeris of a global navigation satellite system, such as ionosphere, clock, and orbital parameters of a GPS satellite and receiver. The locally-optimized satellite clock parameter compensates for geographically-specific signal errors that cannot be compensated by any global parameter of the broadcast ephemeris. The enhanced broadcast ephemeris error corrections are transmitted in the conventional RINEX format.

### CROSS REFERENCE TO RELATED APPLICATIONS

The present application claims priority to U.S. Provisional Patent Application No. 61/703,737, filed on Sep. 20, 2012, and may be related to U.S. patent application Ser. No. 12/208,525, filed Sep. 11, 2008 (Attorney Docket No. P274-US), the disclosure of which is incorporated herein by reference in their entirety.

### STATEMENT OF GOVERNMENT GRANT

The invention described herein was made in the performance of work under a NASA contract, and is subject to the provisions of Public Law 96-517 (35 USC 202) in which the Contractor has elected to retain title.

### TECHNICAL FIELD

The present disclosure relates to systems and methods for the aiding positioning, navigation, and timing with global navigation satellite systems (GNSS), and in particular with the global positioning system (GPS).

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 describes an embodiment of the disclosure for aiding GPS positioning.

FIG. 2 illustrates an embodiment of a method for aiding GPS positioning.

FIG. 3 describes an embodiment of a hardware device implementing one embodiment of the disclosure.

### SUMMARY

In a first aspect of the disclosure, a method for assisted global navigation satellite system positioning by an enhanced broadcast ephemeris (e-BCE) system is described, the method comprising: acquiring a broadcast ephemeris from a global navigation satellite system (GNSS) satellite with a global ground tracking network system, the broadcast ephemeris comprising a broadcast clock state; acquiring an approximate location information from a receiver by the e-BCE system; acquiring range signals from the satellite to the receiver; generating error corrections for parameters in the broadcast ephemeris by the e-BCE system; generating locally-optimized error corrections for the range signals by the e-BCE system; adjusting the broadcast clock state based on the error corrections and the locally-optimized error corrections by the e-BCE system, thereby generating an adjusted broadcast ephemeris; inserting the adjusted broadcast ephemeris parameters into a data message formatted in a receiver-independent exchange format by the e-BCE system; and transmitting the data message from the e-BCE system to the receiver, thereby aiding and improving its positioning solutions.

In a second aspect of the disclosure, a method of aiding global navigation satellite system positioning is described, the method comprising: acquiring a broadcast orbital ephemeris from a satellite with a broadcast ephemeris system; generating error corrections on the broadcast orbital ephemeris with the broadcast ephemeris system; inserting the error corrections in a clock signal of a data message formatted in a receiver independent exchange format; transmitting the error corrections from the broadcast ephemeris system to a receiver, thereby augmenting its positioning information.

In a third aspect of the disclosure, an apparatus for aiding global navigation satellite system positioning is described, the apparatus comprising: a communication link from a satellite to an enhanced broadcast ephemeris (e-BCE) system; a communication link from a receiver to the e-BCE system; a communication link from the satellite to the receiver; wherein the e-BCE system is configured to generate error corrections based on a geographical location of the receiver, and wherein the error corrections are generated in part using an optimized clock value that is derived on the basis of a predicted propagation delay of a GPS signal propagating from the satellite to the receiver through an ionosphere.

In a fourth aspect of the disclosure, a system for augmenting global navigation satellite system positioning is described, the system comprising: a plurality of satellites; a broadcast ephemeris system; a receiver, configured to receive range signals from the plurality of satellites and broadcast ephemeris information from the broadcast ephemeris system.

### DETAILED DESCRIPTION

The Global Positioning System (GPS) and other space-based satellite navigation systems provide an invaluable service in everyday life. A great number of people carry with them a smartphone with an embedded GPS receiver. The GPS ranging signals are subject to several sources of delay and distortion, such as atmospheric delays, that if not properly modeled and corrected will adversely influence the performance and accuracy of GPS receivers. Also, several key navigation parameters necessary for calculation of user-positioning are broadcasted by the GPS satellites, such as the orbital parameters and clock states of the satellites. These parameters contain errors that also adversely affect the positioning performance of GPS receivers. Therefore, several techniques have been developed to aid and improve the performance of GPS receivers by modeling and correcting the signal delays, and by correcting the values of the navigation parameters broadcast by the GPS satellites. The present disclosure describes systems and methods to aid GPS positioning. The GPS satellites broadcast several parameters necessary for the functioning of the GPS receivers.

Low cost GPS-based Position and Navigation Devices (PND), such as in modern smartphones, depend on information embedded in the GPS navigation message to provide the key navigation parameters, such as the orbital and clock states of the satellite, and to correct for key error sources impacting ranging signals and the positioning algorithms.

The orbital and clock parameters embedded in the GPS navigation message comprise the ‘broadcast ephemeris’. The ‘broadcast ephemeris’ for every satellite is predicted hours and days in advance of their actual validity time by the GPS Operational Control Segment, and are uploaded infrequently (typically once or twice per day) to the satellite for eventual transmission to the user with the navigation message.

One way to aid and improve GPS positioning is to generate an improved ephemeris, as calculated by a processor, and transmit this improved ephemeris at time intervals to GPS receivers.

Although in the present disclosure some embodiments may refer specifically to GPS systems, the person skilled in the art will understand that the techniques and systems described may be applied also to other satellite positioning systems, which are known generally as Global Navigation Satellite Systems (GNSS).

As known in the art, a data format used to interchange raw satellite navigation system data is RINEX, Receiver Independent Exchange Format. This format allows the transmission of data independently of the receiver, allowing worldwide compatibility.

To improve upon the accuracy of the broadcast ephemeris parameters augmentation systems have been devised, comprising of ground stations that receive GPS data from the satellites, advanced signal, orbit and environmental models, and estimation algorithms that enable accurate orbit and clock determination. The improved, up-to-date ephemerides can then be transmitted directly to users, through radio signals, Internet, cell phone networks, or other channels, incurring little delay.

For example, the Global Differential GPS (GDGPS) System, operated by the Jet Propulsion Laboratory (JPL), employs a large ground network of real-time reference receivers and real-time data processing software. The GDGPS System can provide accurate real-time GPS ephemerides that support decimeter (10 cm) positioning accuracy and sub-nanosecond time transfer accuracy anywhere in the world, on the ground, in the air, and in space, independent of local infrastructure. The GDGPS System can be used for assisted GPS, namely A-GPS.

In the present disclosure, systems and methods for enhanced broadcast ephemeris (e-BCE) are described. These represent a novel technique for assisted GNSS (A-GNSS) positioning, which comprises the use of the conventional RINEX broadcast ephemeris format. The systems and methods of the disclosure attempt to compensate for several key error sources in user positioning. Enhanced broadcast ephemeris (e-BCE) can enable mobile wireless devices to obtain meter-level positioning without altering existing protocols or data interfaces anywhere along the A-GNSS communications chain.

As known to a person skilled in the art, broadcast ephemeris files in RINEX format are a staple of current A-GNSS services. Such ephemeris can enable faster time-to-first-fix (TTFF) by eliminating the need for the GNSS chipset to acquire and decode the broadcast ephemeris. (TTFF is a measure of the time required for a GPS receiver to acquire satellite signals and navigation data, and calculate a position solution, or fix). The broadcast ephemeris can support positioning accuracy of about 4 meters rms (root mean square) for a typical single-frequency, P-code tracking receiver in the mid-latitudes. This error is driven primarily by the low accuracy 8-parameter ionospheric model (known as the Klobuchar model) employed by GPS, and by errors in the broadcast clock state.

The e-BCE can use data derived from JPL's dense GDGPS tracking network using advanced orbit and environmental models. The e-BCE may be tailored to incorporate precise ionospheric delays as experienced by users in any specific region of the world. The enhanced ephemeris can also contain more accurate clock states based on short-term (up to 2 hours) prediction of precise real-time clock estimates which are computed by the GDGPS System. Additional enhancements include updated inter-signal bias, precise orbit ephemeris, and predicted signal delay due to the neutral atmosphere, as experienced by users in the targeted geographical area. The combined effects of all these enhancements typically result in an improvement by a factor of 2 to 5 in User Range Error, leading to a similar improvement in positioning accuracy.

During periods of solar maximums in the 11 years sun cycle, the relative improvement from the enhanced broadcast ephemeris increases even further, compared to the values cited above. The improvement is also more significant in the low and high latitudes, where ionospheric activity is more pronounced.

Typical PNDs use the L1(CA) range measurements to perform point-positioning. The range expresses the distance between the satellite transmitting the signal and a GPS receiver receiving the signal. The range to each satellite is obtained by multiplying the speed of light by the time the signal has taken from the satellite to the receiver, which is the time of reception minus the time of transmission. To determine its position, a receiver will generally measure the ranges to (at least) four satellites. To complete its positioning calculation the receiver also requires the positions of the satellites at the time of transmission, and the timing error (or state) of the onboard clock. Knowing the satellites' orbital parameters, these positions can be calculated for any point in time.

As known to a person skilled in the art, statistically and approximately, the positioning error for a receiver using L1 (CA) range measurements obeys the simple formula

σ(3D Position error)=PDOP*URE

where PDOP stands for Position Dilution of Precision and is a function of the observed geometry, while URE (User Range Error) is the statistical representation of errors in the line-of-sight range measurements, including any modeling errors.

An analogous formula is available for the horizontal positioning accuracy, where PDOP is replaced by the HDOP (Horizontal Dilution of Precision) coefficient, which is also a function of the observing geometry.

The URE consists of the root-sum-square (RSS) of a number of independent error sources. Important error sources inherent in models and parameters of the GPS navigation message comprise:
1. Orbital state errors
2. Clock state errors
3. Ionospheric state error
4. τgd (P1-P2 inter-frequency code bias) errors
5. CA-P1 inter-signal code bias

As known in the art, P1 and P2 are the ranges measured at the GPS L1 and L2 frequencies, respectively, with τgd being the satellite-specific differential group delay between the P1 and P2 ranging signals. CA stands for coarse acquisition (the civilian signal if military precision is not authorized).

The above error source 5. is not a parameter of the navigation message currently available to users of the CA code, but its absence from the navigation message forces these users to ignore this important satellite-specific bias which can reach a magnitude of 30 cm for some satellites.

Certain space-based augmentation systems (SBAS) for satellite positioning systems, such as the Federal Aviation Administration's Wide Area Augmentation System (WAAS), provide over-the-air corrections to some of the above error sources, namely, the orbit and clock states, and the ionospheric errors. But these signals are not available globally, and have limited observability even over their coverage area because they are transmitted from one or two geosynchronous satellites that are typically low on the horizon for users in the WAAS coverage area. They also require special hardware and software in the PND.

In contrast, the JPL Global Differential GPS (GDGPS) System has been producing real-time corrections for all these error sources for many years, and has been distributing them over the Internet and over direct land lines to its diverse set of customers. In particular, the virtual reference site (VRS) product line bundles corrections for all the above five error sources (and for tropospheric delay as well) as viewed from a specific geographic area, into a single RTCM-type message specific to that area. (RTCM stands for Radio Technical Commission for Maritime Services). However, most PNDs and assisted-GPS (A-GPS) servers do not support the RTCM standard, and cannot tolerate the attendant bandwidth.

On the other hand, most A-GPS protocols and servers do support the transfer of all or part of the GPS navigation message, and in particular the broadcast ephemeris and ionospheric parameters of the message (the latter known as Klobuchar parameters). Several embodiments of the present disclosure comprise the generation of a synthetic broadcast ephemeris, that contains corrected parameters values to account for the above key error sources. PNDs receiving this A-GPS data are able to significantly reduce the URE they experience, and realize a proportional (through the PDOP or HDOP factors) improvement in positioning error.

An important challenge in fitting all these correction types into the limited broadcast ephemeris set of parameters stems from the fundamentally global scope of the broadcast ephemeris data. In contrast, the ionospheric corrections which are needed to realize a significant reduction in URE are highly localized. One solution, as described in the present disclosure, is to produce localized versions of the broadcast ephemeris, each targeted and optimized for a limited geographical area, but otherwise formatted exactly the same, following the popular A-GPS standards, and in particular, the RINEX navigation file format. In other embodiments, though, the synthetic broadcast ephemeris can be constructed to also deliver optimal corrections on a global scale, including improved Klobuchar ionospheric parameters, so as to improve the satellite positioning of users who cannot have access to the geographically optimized versions.

### User Range Error Budget Reduction

Table 1 summarizes several URE components experienced by PNDs tracking CA range measurements with and without the application of the GDGPS corrections to the broadcast ephemeris parameters.

TABLE 1

| | | URE with |
|---|---|---|
| | URE with | GDGPS Synthetic |
| Error Source | Broadcast Ephemeris | Broadcast Ephemeris |
| Orbit and Clock states | 0.8 m | 0.2 m |
| Ionospheric states | 3 m | 0.5 m |
| τgd | 0.2 m | 0.1 m |
| CA-P | 0.3 m | 0 m |
| Troposphere | 0.2 m | 0.2 m |
| Noise | 0.2 m | 0.2 m |
| Multipath | 0.5 m | 0.5 m |
| RSS | 3.2 m | 0.8 m |

In Table 1, ‘Ionospheric states’ refers, as an example of a period within the solar cycle, to the summer of 2012, which had a mildly elevated solar activity compared to mean solar cycle. The appropriate value for the real-time solar cycle would be used in an actual application.

In Table 1, ‘Multipath’ refers to typical value for high-quality test sites such as those used during tests performed to assess the impact of the corrections. Actual values could vary considerably, depending on the location of the receivers and the directions of the received GPS (or GNSS) signals.

In Table 1, ‘Troposphere’, ‘Noise’, and ‘Multipath’ error sources are not impacted by the GDGPS corrections.

### Orbital and Clock State Errors

The broadcast ephemeris provides information about the GPS satellite orbital and clock states. These states are estimated in real-time by the GPS Operational Control Segment, predicted forward in time, and then fit to the broadcast ephemeris format and uploaded a few times per day to the satellites. At the time of the broadcast transmission, the average age of the ephemeris, as monitored by the GDGPS System, can be about 11 hours. This time would be the time that has passed since the orbit and clock states have last been predicted from the last orbit determination instance. The dominant error sources in the broadcast ephemeris are due to the long prediction periods. The combined effect on the range measurement of a terrestrial user is captured by the URE formula

UREₑₚₕₑₘ=sqrt[(dᵣ−dₜ)²+(d_{c}²+dᵢ²)/50]

where dᵣ is the radial orbit error, dₜ is the clock error, d_{c} is the orbit cross-track error, and dᵢ is the orbit in-track error. For the typical example of Table 1, the RMS UREₑₚₕₑₘ is 0.8 m, as monitored by the GDGPS System.

The GDGPS System produces a replacement ephemeris that improves upon several error sources of the broadcast ephemeris. It is based on the real-time GPS orbit and clock states produced by the GDGPS System, which possess sub-0.1 m RMS URE. These states are predicted forward two hours, which is normally just long enough to support the communication with the PND. Special short-term prediction algorithms for the orbit and clock can be employed to minimize the prediction errors. The URE of the 2-hour predicted ephemeris (orbit and clocks) after 2 hours is 0.2 m RMS, as measured against the precise post-processed GPS orbit and clock states from JPL. Finally, the synthetic broadcast ephemeris can be created by performing a least-squares fit of the 2-hour predicted ephemeris to the 17 broadcast ephemeris parameters. The fit error contributes a relatively negligible RMS URE error of just 0.07 m.

This component of the synthetic broadcast ephemeris is uniformly valid globally, reducing the URE contribution of the broadcast orbit and clock states for any user from 0.8 m to 0.2 m.

### Ionospheric Errors

The ionospheric delay for an L1 ranging signal can be provided by the broadcast ephemeris through a set of 8 parameters of the Klobuchar model. These parameters are updated on a daily basis, and this latency is a leading source of error for the accuracy of the broadcast ionospheric delays. Another influential error source stems for the limited fidelity and resolution of the Klobuchar model, which have an accuracy floor of about 0.5 m.

The state of the ionosphere is highly variable, temporally and geographically, with increasing intensity and variability near the peak of the 11-year solar cycle (for example, a solar cycle peak is expected in 2013). Likewise, the errors in any ionosphere model are highly variable, with peaks at low latitude regions, and around local noon. Using JPL's post-processed Total Electron Content (TEC) values at truth, the error in the broadcast ionosphere model can be roughly 3 m RMS.

Based on real-time dual frequency measurements from its vast global tracking network, the GDGPS System normally produces total electron content (TEC) values on a 2°×2° global grid every 5 minutes.

The error of the real-time TEC estimates can be 36 cm rms, as assessed by the residuals of the TEC estimation process.

To correct the broadcast ionosphere model, in some embodiments a first fit is carried out, fitting the Klobuchar model to the GDGPS real-time TEC values, by estimating the 8 model parameters. These estimated parameters can then replace the corresponding parameters of the broadcast ephemeris to provide for a more accurate global model. However, the Klobuchar model can lack accuracy in capturing the full resolution and accuracy of the GDGPS TEC values.

In the present disclosure, the ionospheric residual line of sight corrections are applied to the broadcast clock, and restrict the resulting synthetic ephemeris to a geographical region where these corrections are valid. This procedure enables taking advantage of the fact that, for a set of regional users, all range corrections are additive, and the breakdown of the corrections by model is immaterial.

Therefore, the present disclosure presents an important advantage of being able to provide locally optimized error correction.

As known to the person skilled in the art, GPS positioning for a standard receiver works by acquiring the range to the GPS satellite, and further decoding any additional information provided by the satellite for error correction. Aided GPS systems generally work by acquiring the GPS signal, but obtaining additional navigation parameters and error correction via a separate communications channel. The aided GPS systems also improve the performance of GPS receiver by eliminating the time-consuming task, on the part of the receiver, to decode the additional information from the GPS satellite signal. The TTFF is therefore reduced.

The present disclosure improves on current other methods by calculating (generating) error corrections and transmitting these error corrections to the GPS receiver. A first improvement is the use of a model for the ionosphere which is locally optimized for the known geographic location of the GPS receiver. The GPS receiver only has to acquire the range from the GPS satellites, but can entirely rely on the aiding GPS system of the present disclosure for all error corrections. As the general geographical area of the GPS receiver is known (for example using known cell tower locations, or the receiver's approximate position estimates), the ionospheric model delay which is expected for signals travelling from the GPS satellite to that GPS receiver can be calculated. This delay, if transmitted to the GPS receiver, can improve its positioning. This ionospheric model can be referred to as locally-optimized.

The conventional assisted GPS protocols relay the key navigation message parameters (including the broadcast ephemeris and the Klobuchar parameters) to the receiver. The message parameters, which are defined in the RINEX navigation file format, are global in scope, and do not lend themselves to a locally-optimized value. The solution described by the present disclosure is to incorporate the localized ranging delay corrections (for example, due to the ionosphere) into the clock state parameters.

The locally-optimized aiding message, can thus preserve the conventional assisted GPS format because it does not contain any new parameters, while possessing additional information (in the form of modified satellite clock states, and other parameters) that significantly enhance the positioning performance of receivers in the targeted area.

This worldwide and backward compatible method is enabled by the use of the standard RINEX format, which is compatible with many assisted GPS systems and receivers.

The other error corrections incorporated by the methods of the present disclosure comprise correction of orbital state, τgd and CA-P1, all of which can be incorporated into one RINEX formatted package.

In particular, τgd require complex calculations and have not been incorporated before into a RINEX package comprising other error corrections.

Furthermore, the CA-P1 delay error is not currently accounted for by GPS receivers as this information is not included in the GPS navigation message, and heretofore has not been part of any assisted GPS service. Uncorrected CA-P1 delay introduces an additional error in positioning. The methods and systems of the present disclosure allow the correction of the CA-P1 error by bundling it with the other error correction information into a RINEX package without altering the standard format.

In several embodiments of the present disclosure, all the above-mentioned five error corrections (clock, orbital, ionospheric, τgd, and CA-P1) are transmitted as a RINEX format message to GPS receivers worldwide, providing locally optimized positioning in a standardized and readily available format.

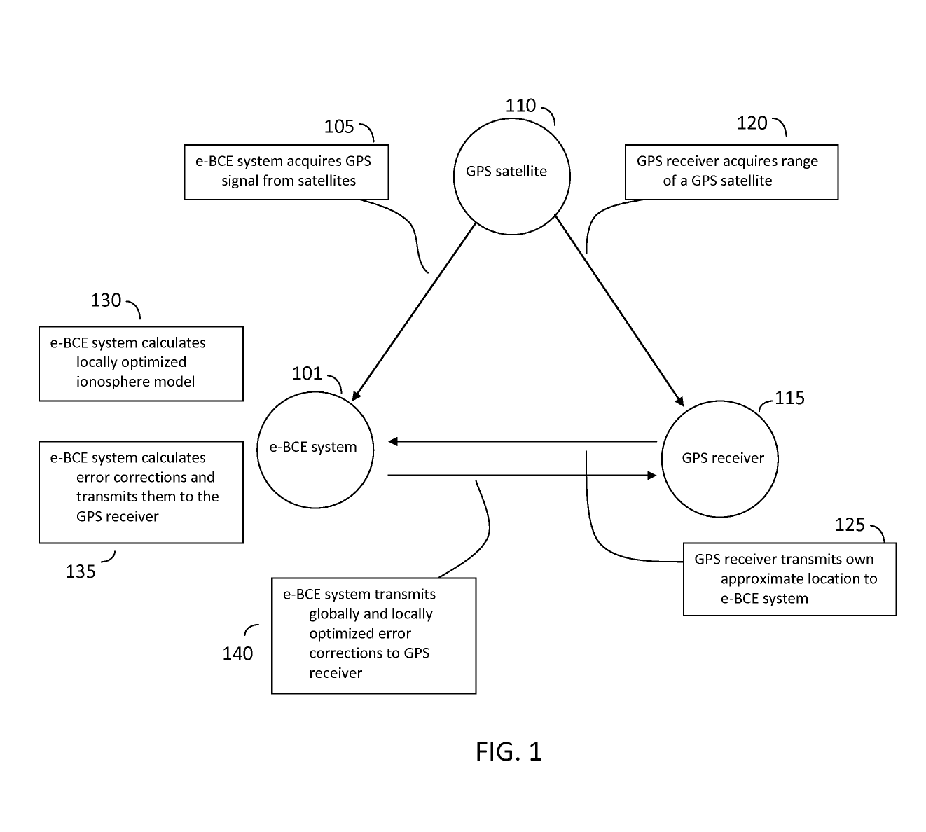

In several embodiments of the present disclosure, methods and systems for locally optimized GPS positioning are described, comprising several steps and components, as illustrated, for example, in FIG. 1.

Referring to FIG. 1, an e-BCE system (101) acquires a GPS signal (105) from all GPS satellites (110). A GPS receiver (115) acquires the range (120) of a GPS satellite (110). The GPS receiver (115) also transmits its own approximate location (125) to the e-BCE system (101).

The e-BCE system (101) then calculates the locally optimized ionosphere model (130) for the location of the GPS receiver (115), and the appropriate error correction (135) to be sent in the form of a broadcast clock state to the GPS receiver (in RINEX format). The e-BCE system (101) also calculates the other error corrections (135), comprising, for example, clock, orbital, τgd, and CA-P1. The error corrections (135) may be globally optimized, locally optimized, or both.

The e-BCE system (101) then transmits the error corrections in RINEX format (140), both globally and locally optimized to the GPS receiver (115).

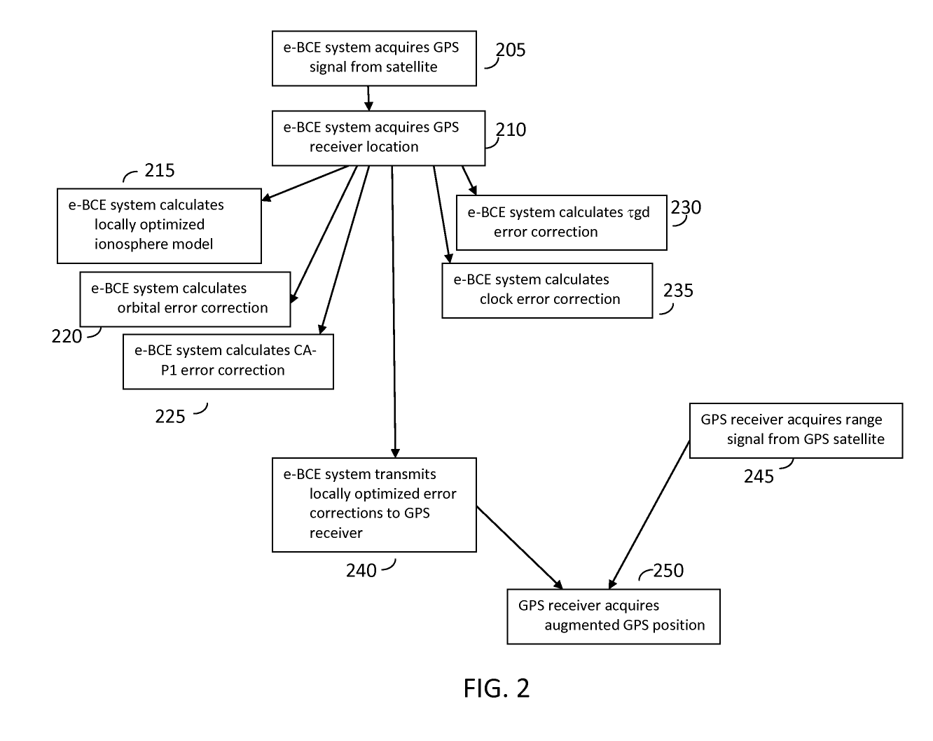

One embodiment of a method of the disclosure is illustrated in FIG. 2. The e-BCE system acquires GPS signals from the GPS satellites (205). The e-BCE system then acquires the GPS receiver approximate location (210). The e-BCE system then calculates the locally optimized ionosphere correction (215), the orbital correction (220), the CA-P1 correction (225), the τgd correction (230), and the clock correction (235).

The e-BCE system then transmits the locally optimized error corrections to the GPS receiver, in the clock part of the RINEX GPS data message (240). The GPS receiver acquires the range signal from the GPS satellite (245). Finally, the GPS receiver is able to acquire an optimized GPS positioning (250).

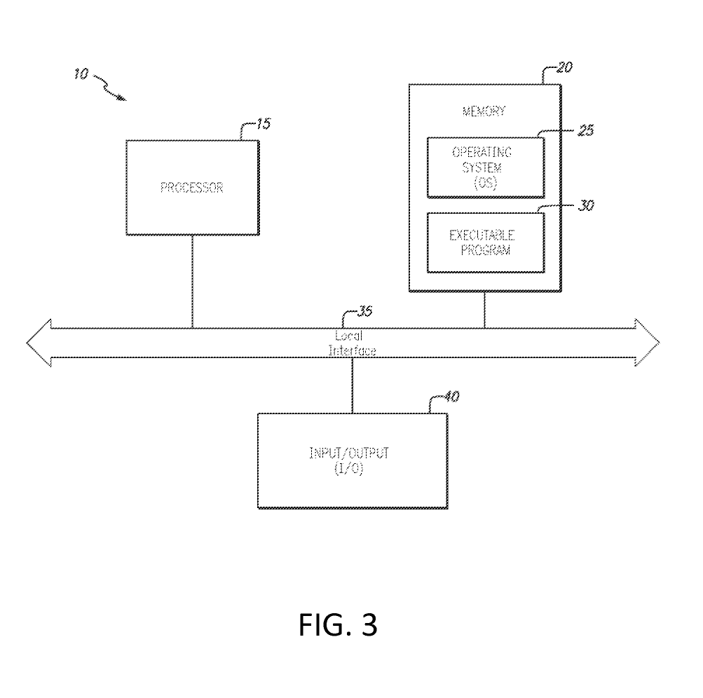

FIG. 3 is an exemplary embodiment of a target hardware (10) (e.g. a computer system) for implementing the embodiments of FIGS. 1 to 2 for augmented GPS positioning. This target hardware comprises a processor (15), a memory bank (20), a local interface bus (35) and one or more Input/Output devices (40). The processor may execute one or more instructions related to the implementation of FIGS. 1 to 2, and as provided by the Operating System (25) based on some executable program stored in the memory (20). These instructions are carried to the processors (20) via the local interface (35) and as dictated by some data interface protocol specific to the local interface and the processor (15). It should be noted that the local interface (35) is a symbolic representation of several elements such as controllers, buffers (caches), drivers, repeaters and receivers that are generally directed at providing address, control, and/or data connections between multiple elements of a processor based system. In some embodiments the processor (15) may be fitted with some local memory (cache) where it can store some of the instructions to be performed for some added execution speed. Execution of the instructions by the processor may require usage of some input/output device (40), such as inputting data from a file stored on a hard disk, inputting commands from a keyboard, outputting data to a display, or outputting data to a USB flash drive. In some embodiments, the operating system (25) facilitates these tasks by being the central element to gathering the various data and instructions required for the execution of the program and provide these to the microprocessor. In some embodiments the operating system may not exist, and all the tasks are under direct control of the processor (15), although the basic architecture of the target hardware device (10) will remain the same as depicted in FIG. 3. In some embodiments a plurality of processors may be used in a parallel configuration for added execution speed. In such a case, the executable program may be specifically tailored to a parallel execution. Also, in some embodiments the processor (15) may execute part of the implementation of FIGS. 1 to 2, and some other part may be implemented using dedicated hardware/firmware placed at an Input/Output location accessible by the target hardware (10) via local interface (35). The target hardware (10) may include a plurality of executable program (30), wherein each may run independently or in combination with one another.

The examples set forth above are provided to those of ordinary skill in the art a complete disclosure and description of how to make and use the embodiments of the gamut mapping of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The methods and systems described in the present disclosure may be implemented in hardware, software, firmware or any combination thereof. Features described as blocks, modules or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), or a field programmable logic array (FPGA)).

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A method for assisted global navigation satellite system positioning by an enhanced broadcast ephemeris (e-BCE) system, the method comprising:
acquiring a broadcast ephemeris from a global navigation satellite system (GNSS) satellite with a global ground tracking network system, the broadcast ephemeris comprising a broadcast clock state;
acquiring an approximate location information from a receiver by the e-BCE system;
acquiring range signals from the satellite to the receiver;
generating error corrections for parameters in the broadcast ephemeris by the e-BCE system;
generating locally-optimized error corrections for the range signals by the e-BCE system;
adjusting the broadcast clock state based on the error corrections and the locally-optimized error corrections by the e-BCE system, thereby generating an adjusted broadcast ephemeris;
inserting the adjusted broadcast ephemeris parameters into a data message formatted in a receiver-independent exchange format by the e-BCE system; and
transmitting the data message from the e-BCE system to the receiver, thereby aiding and improving its positioning solutions.

2. The method of claim 1, wherein the adjusted broadcast ephemeris parameters comprise orbit and clock states, ionospheric parameters, and inter-signal group delay (Tgd) parameters, thereby generating adjusted orbit and clock states, adjusted ionospheric parameters and adjusted inter-signal group delay parameters.

3. The method of claim 2, wherein the adjusted orbit and clock states are based on real-time orbit determination operations for the GNSS satellite, and wherein estimated real-time orbit and clock states are optimally predicted for a future time period, wherein the future time period comprises a time period between 2 and 4 hours.

4. The method of claim 2, wherein the ionospheric parameters are based on a global real-time ionospheric model, and wherein real-time ionospheric parameters are optimally predicted for a future time period, wherein the future time period comprises a time period between 2 and 4 hours.

5. The method of claim 2, wherein the Tgd parameters are estimated as part of a real-time ionospheric estimation process, thereby generating an estimated Tgd.

6. The method of claim 5, further comprising determining, by the e-BCE system, a coarse acquisition inter signal (CA-P) bias of the GNSS satellite in a daily process, and wherein the CA-P bias is added, by the e-BCE system, to the estimated Tgd for the GNSS satellite in the adjusted broadcast ephemeris.

7. The method of claim 2, further comprising:
fitting, by the e-BCE system, a Klobuchar model to an estimated real-time ionosphere;
deriving, by the e-BCE system, eight globally-optimized Klobuchar parameters; and
inserting, by the e-BCE system, the Klobuchar parameters into the adjusted broadcast ephemeris.

8. The method of claim 7, further comprising minimizing, by the e-BCE system, ionospheric modeling errors along a line-of-sight between the receiver and an observed global positioning system (GPS) satellite by adding, by the e-BCE system, local residuals of a fit between the Klobuchar model and the estimated real-time ionosphere to the broadcast clock state for all GNSS satellites observed by the receiver in a given geographical location.

9. A method of aiding global navigation satellite system positioning, the method comprising:
acquiring a broadcast orbital ephemeris from a satellite with a broadcast ephemeris system;
generating error corrections on the broadcast orbital ephemeris with the broadcast ephemeris system;
inserting the error corrections in a clock signal of a data message formatted in a receiver independent exchange format;
transmitting the error corrections from the broadcast ephemeris system to a receiver, thereby augmenting its positioning information.

10. The method of claim 1, wherein the transmitting is carried out over a wire-line communication link or a wireless communication link.

11. The method of claim 10, wherein the wireless communication link is a cell phone network.

12. The method of claim 1, wherein the locally-optimized error corrections are transmitted every 2 hours.

13. The method of claim 1, wherein the receiver is a GPS receiver.

14. An apparatus for aiding global navigation satellite system positioning, the apparatus comprising:
a communication link from a satellite to an enhanced broadcast ephemeris (e-BCE) system;
a communication link from a receiver to the e-BCE system;
a communication link from the satellite to the receiver;
wherein the e-BCE system is configured to generate error corrections based on a geographical location of the receiver, and wherein the error corrections are generated in part using an optimized clock value that is derived on the basis of a predicted propagation delay of a GPS signal propagating from the satellite to the receiver through an ionosphere.

15. The apparatus of claim 14, wherein the receiver is part of a cellular phone, a tablet, a mobile computer or a desktop computer.

16. A system for augmenting global navigation satellite system positioning, the system comprising:
a plurality of satellites;
a broadcast ephemeris system;
a receiver, configured to receive range signals from the plurality of satellites and broadcast ephemeris information from the broadcast ephemeris system.

17. The system of claim 16, wherein the receiver is a GPS receiver.
